(19) United States
(12) Patent Application Publication
(10) Pub. No.: US 2002/0071651 A1
(43) Pub. Date: Jun. 13, 2002

(54) Method of indexing and printing user specified frames during playback or contemporaneous video recording

(76) Inventors: William Hastings Wurz, San Francisco, CA (US); Rickson Sun, Palo Alto, CA (US); David John Gilmore, San Francisco, CA (US); Elinor Jane Fulton Suri, Berkeley, CA (US); Michael S. Viola, Burlington, MA (US)

Correspondence Address: Paul M. Coryea, POLAROID CORPORATION, Patent Department, 784 Memorial Drive, Cambridge, MA, 02139, US

(21) Appl. No.: 09/944,962

(22) Filed: Aug. 31, 2001

Related U.S. Application Data
(60) Provisional application No. 60/229,418, filed on Aug. 31, 2000.

(51) Int. Cl. H04N 5/92; H04N 7/00; H04N 5/783

(52) U.S. Cl. 386/46; 386/69

(57) ABSTRACT

A method of indexing and retrieving user specified frames during recording or playback of video images by providing a hard copy representation of such images which contain encoded frame location information for accessing the images on the recording medium. The invention also provides digital transfer of user selected frames on to a digital video disc so as to provide a sequence of selected frames. It further provides a mark in the header of the video disc to enable random access of a desired frame in the sequence of selected frames.

### FIELD

The present invention relates in general to image indexing during recording or playback of a video recording medium, and in particular, an index that provides an image and location of such image for quick access to a hardcopy or video of a desired image.

### BACKGROUND

The concept of using hardcopy as a means of indexing and accessing video recordings is generally known. For example, a number of patents reveal the use of barcode indices to access video information recorded in either compact disc format and/or videotape format. The concept of an off-tape video index comprising an image and bar coded location information is also known. U.S. Pat. No. 5,689,610 issued on Nov. 18, 1997 to Manico et. al., discloses an index print including a recording sheet having a plurality of imagettes representing images stored on a motion picture image recording medium. The plurality of imagettes are less in number than an entire number of images stored on the motion picture image recording medium. An indicator is provided on the recording sheet adjacent at least one of the imagettes for indicating substantially where an image, corresponding to the at least one imagette, is stored on the motion picture image recording medium. The indicator allows the user to quickly and precisely locate that image on the recording medium without wasting time and without trial and error. In essence, Manico discloses the use of an “index print” comprising “imagettes” to enable specific recording locations on a video tape. U.S. Pat. No. 5,233,485 issued on Aug. 03, 1993, to Yang discloses a method and system for an index search.

One disadvantage with the method of making an index print as disclosed in Manico et al., or the system in Yang is that the imagette on the recording sheet represents an image stored on a tape or a disk. Manico discloses the use of an index print comprising imagettes with location indicators to enable access to specific locations on a video tape. The search and index mechanism is provided as an after stage of a video recording. While this serves the need for providing immediate quick access to a desired location of images stored on tape or disc, such access cannot be accomplished during contemporaneous recording so that as the video sequences are recorded, a user can quickly capture and index a desired frame. There also remains an unmet need to be able to print such images of desired frames during contemporaneous recordation with such prints being capable of providing access to the location of such image.

### SUMMARY

In light of the above need, the present invention provides—as its most preferred embodiment—a method of indexing video images, where such images can be indexed and saved during recordation, and then providing the capability to store and retrieve at a later time. Such a method provides the capability of providing a hardcopy print during recordation or at the time of copying or viewing. The hardcopy will provide an image depicting any user specifiable image along with corresponding encoded frame location information of such an image for quick and automatic access of such images.

In a product embodiment of the invention, the system provides a method of indexing, scanning, and reproducing user specified frames from a motion picture video with a hardcopy representation of such selected frames during recordation or playback of a video capture device. This hardcopy will have the capability to provide encoded frame location information which can be scanned quickly and automatically to provide ready access to the specified location. The system also provides indexing capability to a digital camcorder by means of digital transfer of a sequence of video image frames on to a disc recording unit. The digital transfer step includes placing a mark at the location of the frame and writing the marks on a header track of the recording disc. The marks provide quick and random access to a desired image frame, analogous to accessing a desired track on a music compact disc.

The method embodiment of the invention provides a means for indexing sequence of video frames during contemporaneous recording or playback of video images. The method also provides a hardcopy representation of the sequence of images selected which gives an image as well as corresponding encoded information to read the location of the image. The method further provides a process of converting the collection of index sequences to a digital form on a recording unit, which saves a frame from the desired sequence, and also places a mark at that location on the recording unit. The collection can then be later viewed with quick access to each desired image as a header track on a compact disc. The method also provides printing capability either during recordation or later during playback viewing or copying.

The invention as a result provides users of video recordings easy organization of their video collections and avoids long searches to find a desired sequence. In light of the above, the present invention is directed to overcoming one or more of the problems set forth above.

It is an objective of the present invention to provide a method and system for searching and ready retrieval of desired select frames during recording or playback of a video disc or tape.

It is another objective of the present invention to eliminate long visual searches of a recording to find a desired sequence and provide quick and random access.

It is yet another objective of the invention to store representation of user specified frames in an album and access the same by scanning the encoded frame location information.

Still another objective of the present invention to provide a digital camcorder with the capability of providing a header on a video disc that gives an index of user selected frames that are captured during recordation or playback of a video image capture device.

It is also an objective of the invention to provide a printer in such a digital camcorder which can print user selected still images either during recordation at the camcorder or during playback at the monitor viewing output.

It is yet another objective of the invention to provide a hardcopy representation of user selected still images from a motion picture recording either during recordation or playback of a video image capture device.

It is another object of the invention to provide a printing device with the capability of providing a hardcopy representation of user specifiable image frames during recordation or playback of a video image capture device with the hardcopy print capable of providing an image as well as location of the image frame for scanning and ready access of a sequence of such user selected frames.

### BRIEF DESCRIPTION OF THE DRAWINGS

A better understanding of the objects, features and advantages of the invention can be gained from a consideration of the following detailed description of the preferred embodiment thereof, in conjunction with the figures of the accompanying drawing, wherein:

FIG. 1 is a diagram showing the method of providing a hardcopy of any user specifiable image during recordation or playback, said hardcopy depicting an image and encoded frame location information of any user specifiable image. FIG. 1 also depicts the method of converting a sequence of user specified frames with encoded information to digital form, placing identification marks corresponding to the locations of these specified frames, and subsequently writing these marks on to the header track of the video disc recording unit, for quick and automatic access to a desired frame.

### DETAILED DESCRIPTION

The present invention encompasses a novel method and system of indexing and retrieving user specified frames from a video recordation. Though the use of indexing video images is known in the art (see e.g. U.S. Pat. No. 5,689,610 to Manico et al.) such indexing has not been possible during contemporaneous recordation. Although providing a hardcopy representation of a still image of a video sequence is known in the art (see U.S. Pat. No. 5,255,880), it is not available during contemporaneous recordation. Also, the subsequent digital transfer of a user specifiable video sequence and providing a disc header with video clips of desired sequences has no precedents.

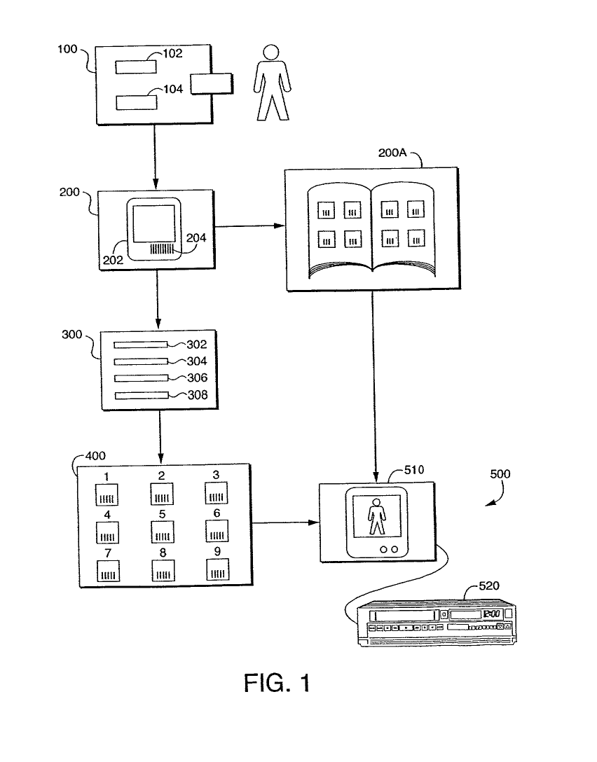

The method in particular encompasses the following steps as detailed in FIG. 1. Many times during video footage of family vacations, or journalistic coverage, the consumer desires to save special moments or edit them later after collecting many tapes. Special moments of a home movie are often embedded in the middle of lengthy footage. To add to the fun and creativity of shooting and editing home movies, digital camcorders provide the capability of editing during recordation. During recordation or after, a user can select a desired image frame to be stored in a memory. After selecting a favorite shot, the user can print a hardcopy representation of the image which provides an image as well as the information to denote the location of the image on the recording medium. This hardcopy may be used later for storing, scanning, retrieving or printing such desired frames. The video recording apparatus as shown in Step 100 provides an image capture device 102, and an image printing device 104. The image capture device 102 provides the capability to record motion picture images on a medium such as a video tape or disc.

It should be noted that the storing step may be eliminated whereby the user provides a hardcopy as an initial step followed by the step of accessing the location of the image by reading the encoded location information.

Systems that provide video recording and play back are well known and available in the art. Step 100 also provides a printing device 104 that can produce a hardcopy representation of a desired image. This hardcopy may be printed contemporaneously while the images are captured or later during playback or editing. The hardcopy as shown in step 200 provides a user specifiable image 202 and a corresponding encoded information 204 to denote the corresponding location of the image 202. The encoded location information 202 for the location of a user specifiable image 202 may be provided by means of a bar code or a magnetic stripe. These indicia can be on the front or back of the print and may be in the form of a 2-dimensional or 3-dimensional representation. Each of the desired images may be printed to obtain a collection of favorite scenes during a particular recording.

In the embodiments presently contemplated the hardcopy representation could be using a silver halide instant film, which is fast and commercially available. The invention is not however limited to providing a hardcopy using silver halide film, but can include other types of film such as 35 mm film, thermal printer, and the like.

In one embodiment of the invention, such prints can be stored in an album as shown in Step 200A. Using a scanning wand, the user can scan these prints to access for viewing on a television monitor. The scanner enables the user to quickly and automatically access the location of the desired frame and eliminates the need to transfer the video sequence. It is well known in the art that video recording devices such as camcorders that serve as their own player come complete with a scanner wand and a television set top box for viewing.

In another embodiment of the invention, the invention provides an integrated unit to achieve video indexing by eliminating the need for hardcopy indexing and the subsequent scanning by using a wand and then accessing such bookmarks. Such an integrated unit also facilitates the digital transfer of the image indexing data to be written on to a digital disc recording unit further creating a digital header which provides quick access to user specifiable video images. The video indexing functionality during recordation allows the user to “index-as-you-record” mode for efficient recording. The indexing is accomplished by selecting a desired frame during play or record mode that the user wishes to index. Commercially available video recording devices, for example, the SONY MD Discam camcorder provides software that may be used to capture every scene change automatically or to capture user desired images. Disc based video gives consumers the speed and freedom to quickly edit video which may not be possible with linear tape-based video systems. The Discam, for example, provides easy-to-use creative controls for efficient editing and copying purposes. The Discam, optionally connects to a computer so users can save still images to their system's hard drive. An index window on the screen shows the starting image of each scene to let users mark each video segment for editing. After indexing the entire length of the tape the user can review the indexed frames and make further edits if desired (ie, eliminate redundant scenes). Simultaneous to the review of the tape is the process of converting the video sequence to a digital form as shown in Step 300 of FIG. 1. Digital scanners are available which scan an object and produce a digital output file. This file can then transferred to the Internet using a computer to share, copy images. Step 300 provides an apparatus for converting the desired images into a digital format and writing this information on to a video disc header. This process is akin to copying video tapes, the difference being that it is digital transfer, and further provides index of locations for quick and automatic access to the same. This process of converting the video sequence to a digital form, “digital video indexing”not only saves a frame from the desired sequence but also places a mark at the location of the digital disc writer. The integrated unit used to provide the digital transfer in Step 300 provides the steps of selecting, indexing, and storing the indexed images on a disc. This embodiment uses an arrangement that is much more automatic than the previous embodiment.

The method for performing such an index search utilizes an apparatus comprising a video signal record processing circuit for recording the video signal on a video disc after converting the video signal into a digital signal. Further, a video signal playback processing circuit is provided for reproducing the digital signal picked up from the video disc and converting the digital signal into an analog signal and outputting the analog signal. An address information record processing circuit also is be provided for recording the address location information on the control track of the disc when the digital video signal is recorded on the disc, and an address location information playback processing circuit for reproducing the address information picked up from the control track of the disc when the digital signal is reproduced from the disc.

First the camcorder tape, whether it be recorded digitally or analog is placed into the integrated unit which allows the user to view the tape on a television monitor. During playback the user can view the content to select desired images. The selection step includes the step of ‘selecting’ a frame and ‘storing it’. This process continues throughout the length of the tape. At the end, the user can review the images stored, to make further edits, such as, deleting redundant images. Simultaneous to the review of the tape is the process of converting the video sequence to a digital form and recording it to the digital video disc and providing a header on the disc to mark with the selected frames. The marking step provides random access to a desired image, analogous to accessing a desired track on a music disc. When the integrated unit is operated in a read mode, the user can simply view the selected frames and based on that viewing further select that portion of the video sequence the user desires to see. Once the selection of desired images is complete, the scenes can be printed in a thumbnail fashion, which can be used as a jacket of the case which holds the video disc. An advantage of the jacket cover that contains a thumbnail representation of desired scenes affords the consumer to determine at a glance which images are stores on the recording medium without having to load the tape, play, and find out the desired locations of scenes by trial and error. The selecting, storing, recording, marking, viewing, and printing functions are provided by the integrated unit. Step 300 includes the steps of selecting and storing a frame at step 302. During this step, the user selects during recordation or playback, a scene that h/she wants to save. This step is repeated until the recordation is complete or the playback is complete, so that there is a collection of a group of scenes that would have been saved and stored. During this step, each scene or frame is stored as an image with a corresponding indicia of the location of the image. Once all user desired images are saved and stored, a review and edit step of 304, facilitates the editing and trimming of scenes so that users may pare down the scenes to avoid duplicated or unwanted images. After the edit step, the scenes selected will be converted to a digital format at step 306. The conversion step of 306 includes writing the video sequence of scenes to a disc recording unit and writing the corresponding marks of the selected scenes on the header track of the disc. Step 300 also includes the step 308 of printing a desired image. It may be understood that this printing step can be performed either right after the initial selecting and storing a frame step at 302 or after the edit and convert steps are performed. The integrated unit provides a printer which will print out the indexed images in a thumbnail fashion. This printer can be any kind of printer, for example, a thermal transfer printer. If formatted appropriately, this hardcopy can serve as the cover for the jacket of the jewel case which holds the video disc as shown in Step 400. The printer can also be used to produce prints of any frame provided on the digital video disc provided there is enough resolution of the recorded image. This is analogous to accessing a desired track on a music audio compact disc. In addition, since the digitally written digital video disc is randomly accessed, this system eliminates the need for searching long sections of a recording to find a desired sequence.

Step 500 shows the step of viewing the indexed frames and printing user selected frames. Thus when the digital video disc is operated in the READ mode, the user can either simply view the video as shown in step 510 or view the selected frames and then based on that viewing select what portion of the video s/he wants to see. Because the digital video disc has been indexed to the user selected frames, the user goes directly to that portion of the video. Step 520 shows a digital video disc playing device which allows the user to access any desired, indexed image. In addition step 500 may include the step of printing a user identifiable image that is being viewed.

It should be obvious to one of ordinary skill in the art that the printing steps of 200, 400 and 500 may be done in any order. The actual order of printing a hardcopy and scanning and transfer of the same will be determined by the nature of application of this invention. It is possible that step 200 may be performed during the uses of this invention in the area of real estate showings or accident investigations. This step may also be eliminated until all desired frames are edited, for example, when one is editing for journalistic coverage, or to get a personal video collection organized.

While the present invention has been shown and described by reference to certain embodiments, it will be appreciated that many changes and modifications may be made therein by one skilled in the art in view of the present disclosure without departing from the essential spirit of the invention as defined in the following claims:

1. A method of indexing and retrieving user specified frames during recordation and playback of video images comprising the steps of:
(a) providing a hard copy representation of any user specifiable image frame during contemporaneous recordation or playback of video images, said hardcopy having an image and corresponding encoded frame location information for locating said image; and
(b) retrieving said user specifiable image frame by using the hardcopy to access the image location by reading the encoded information.

2. The method as in claim 1, wherein said providing step (a) includes the step of employing a video image capture device capable of recordation and playback of video images such as a video cassette recorder or a video disc.

3. The method as in claim 1 wherein said providing step (a) includes the step of employing a printing device for providing a hardcopy representation of the user specifiable image that can serve as a quick access for locating a desired image as well as the location of the image.

4. The method as in claim 1 wherein said providing step (a) utilizes a bar code for locating said pattern of intelligence on said encoded frame location information.

5. The method as in claim 1 wherein said providing step (a) utilizes a magnetic stripe for digital data or sound recording.

6. The method as in claim 1 further including a storing step for storing said user specifiable image and corresponding encoded frame location information, said storing step occurring between the provision step and retrieval step.

7. The method as in claim 6 wherein the storing step provides a video album for physical storing of hardcopy representation of images.

8. The method as in claim 1 wherein said retrieving step (b) provides employing a scanning device to locate quickly and automatically the location of said user-specifiable image frame to read said encoded frame location information and transmit said information to said video image playback device.

9. The method as in claim 3 wherein the printing device is a thermal image transfer device.

10. A method of retrieval of user specified frames during recordation and playback of video images by way of random access of a desired frame on a video disc comprising the steps of:
(a) providing an index representation of any user specifiable image frame during contemporaneous recordation or playback of video images, said index having an image and corresponding encoded frame location information for locating said image;
(b) providing a selected sequence of frames after reviewing and editing said desired frames;
(c) converting said sequence into a digital form to write to a recordable digital video disc;
(d) providing location identifying marks on the recordable digital video disc;
(e) writing the location identifying marks on the header track of the disc to provide quick and easy access;
(f) providing a hardcopy representation of any user specifiable image or said sequence of images so as to provide jacket cover for the video.

11. The method as in claim 9, wherein said providing step (a) includes the step of employing a video image capture device capable of recordation and playback of video images such as a video cassette recorder or a digital video disc recorder.

12. The method as in claim 9 wherein the providing step (d) of hardcopy representation in step (d) includes the step of employing a printing device.

13. The method as in claim 9 wherein said encoded frame location information in step (a) can be in the form of a bar code.

14. The method as in claim 9 wherein said encoded frame location information in step (a) can be in the form of a magnetic stripe.

15. The method as in claim 9 wherein said hardcopy representation in step (d) can be obtained during recordation or playback of a video recording.

16. The method as in claim 13 wherein the printing device is a thermal image transfer device

17. The method as in claim 9 wherein the providing step (d) provides a single image.

18. The method as in claim 9 wherein the jacket cover representation as in step (d) contains thumbnail representations of user specifiable image frames.
